(19) United States
(12) Patent Application Publication
(10) Pub. No.: US 2017/0089562 A1
(43) Pub. Date: Mar. 30, 2017

(54) ILLUMINATION APPARATUS

(71) Applicant: Panasonic Intellectual Property Management Co., Ltd., Osaka (JP)

(72) Inventor: Yoshiyuki NAKANO, Osaka (JP)

(21) Appl. No.: 15/274,146

(22) Filed: Sep. 23, 2016

(30) Foreign Application Priority Data
Sep. 30, 2015 (JP) 2015-195258

(51) Int. Cl. F21V 29/89

(52) U.S. Cl. CPC F21V 29/89; G02B 6/0008

(57) ABSTRACT

An illumination apparatus includes: a housing which is tubular and includes a first end surface through which laser light enters and a second end surface having an opening through which the laser light exits; a light emitter which is in contact with the second end surface of the housing to block the opening, and emits light having a wavelength different from a wavelength of the laser light when illuminated with the laser light passing through the opening; and a condenser lens which is disposed in an internal space of the housing and condenses the laser light onto the light emitter, thereby forming a spot. When viewed along an optical axis of the laser light in the internal space, the opening has a shape larger than the spot of the laser light on the light emitter and smaller than a circumference of the condenser lens.

### CROSS REFERENCE TO RELATED APPLICATION

This application claims the benefit of priority of Japanese Patent Application Number 2015-195258 filed on Sep. 30, 2015, the entire content of which is hereby incorporated by reference.

### BACKGROUND

1. Technical Field

The present disclosure relates to an illumination apparatus which uses laser light emitted by a light source.

2. Description of the Related Art

There is a conventional illumination apparatus which illuminates by causing a phosphor to emit light, using laser light transmitted through an optical fiber as excitation light. The phosphor converts the laser light into light of a desired color to be emitted by the illumination apparatus. For example, Patent Literature 1 (PTL 1: Japanese Unexamined Patent Application Publication No. 2015-65142) discloses a technique related to such an illumination apparatus. The illumination apparatus disclosed in PTL 1 includes a heatsink which dissipates heat generated by the phosphor.

### SUMMARY

Recent years have seen a demand for further efficient dissipation of the heat generated by the phosphor.

In view of this, an object of the present disclosure is to increase the heat dissipation efficiency of an illumination apparatus which uses laser light emitted by a light source.

An illumination apparatus according to an aspect of the present disclosure uses laser light emitted by a light source, and includes: a housing which is tubular and includes a first end surface through which the laser light enters and a second end surface having an opening through which the laser light exits; a light emitter which is in contact with the second end surface of the housing to block the opening, and emits light having a wavelength different from a wavelength of the laser light when illuminated with the laser light passing through the opening; and a condenser lens which is disposed in an internal space of the housing and condenses the laser light onto the light emitter, thereby forming a spot, wherein, when viewed along an optical axis of the laser light in the internal space, the opening has a shape larger than the spot of the laser light on the light emitter and smaller than a circumference of the condenser lens.

According to the present disclosure, it is possible to increase the heat dissipation efficiency of an illumination apparatus which uses laser light emitted by a light source.

### BRIEF DESCRIPTION OF DRAWINGS

The figures depict one or more implementations in accordance with the present teaching, by way of examples only, not by way of limitations. In the figures, like reference numerals refer to the same or similar elements.

FIG. 1 is a perspective diagram illustrating a use of an illumination apparatus according to an embodiment;

FIG. 2 is a perspective diagram illustrating a schematic structure of an illumination apparatus according to an embodiment;

FIG. 3 is a cross section diagram illustrating a schematic structure of an illumination apparatus according to an embodiment;

FIG. 4 is a cross section diagram illustrating a schematic structure of an illumination apparatus according to a comparative example;

FIG. 5 is a cross section diagram illustrating a schematic structure of an illumination apparatus according to Variation 1; and

FIG. 6 is a cross section diagram illustrating a schematic structure of an illumination apparatus according to Variation 2.

### DETAILED DESCRIPTION OF THE EMBODIMENT

Hereinafter, an illumination apparatus according to an embodiment of the present disclosure will be described with reference to the drawings. It is to be noted that the embodiment described below is to show a specific example of the present disclosure. Therefore, the numerical values, shapes, materials, structural elements, and the arrangement and connection of the structural elements, etc., shown in the following embodiment are mere examples, and are therefore not intended to limit the present disclosure. Thus, among the structural elements in the following embodiment, structural elements not recited in the independent claim representing the most generic concept of the present disclosure are described as arbitrary structural elements.

It is also to be noted that each drawing is a schematic illustration and is not necessarily a precise illustration. Furthermore, in the drawings, like reference signs are given to like structural elements.

### Embodiment

Hereinafter, an embodiment will be described.

### Use of Illumination Apparatus

First, a use of an illumination apparatus according to an embodiment will be described.

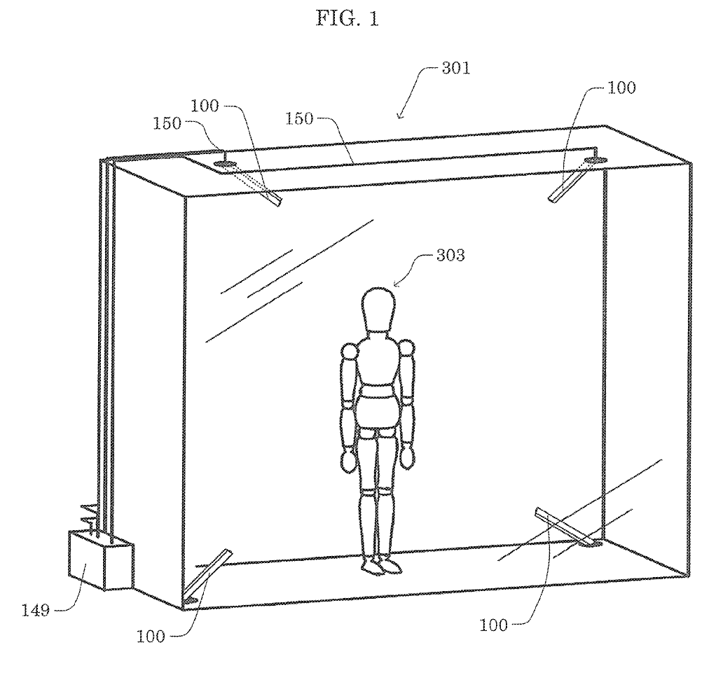

FIG. 1 is a perspective diagram illustrating a use of an illumination apparatus according to an embodiment.

As illustrated in FIG. 1, a plurality of illumination apparatuses 100 are installed on the ceiling and the floor of shop window 301 which is an example of a building structure, and each illumination apparatus 100 functions as a spotlight which illuminates mannequin 303. Light source apparatus 149 is provided outside shop window 301. The laser light emitted by light source apparatus 149 is transmitted to each illumination apparatus 100 by optical fibers 150 which are wired outside shop window 301.

Light source apparatus 149 is an apparatus which generates laser light and supplies the laser light to the plurality of illumination apparatuses 100 through optical fibers 150. Specifically, light source apparatus 149 includes a plurality of semiconductor laser elements which emit laser light having a wavelength in a range from the wavelength of blue-violet light to the wavelength of blue light (i.e., a range from 430 nm to 490 nm), for example. By disposing the semiconductor laser elements at one position, a cooling apparatus which cools the semiconductor laser elements can be centrally provided, thereby increasing the cooling efficiency and enabling use of exhaust heat and the like for water warming, for example.

Each illumination apparatus 100 is an apparatus which emits white light using the laser light transmitted through optical fibers 150 as excitation light.

### Structure of Illumination Apparatus

Hereinafter, a structure of illumination apparatus 100 will be described.

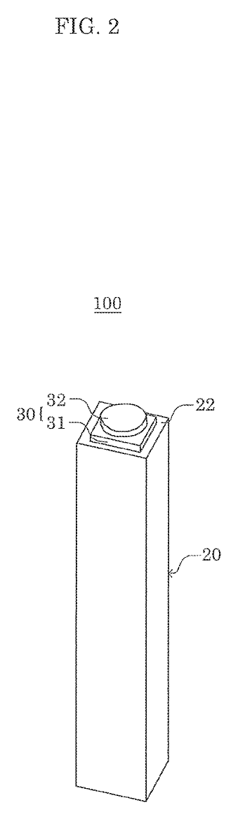

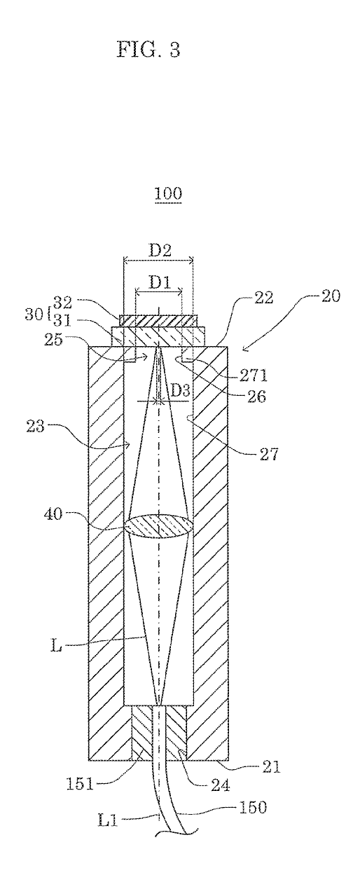

FIG. 2 is a perspective diagram illustrating a schematic structure of illumination apparatus 100 according to an embodiment. FIG. 3 is a cross section diagram illustrating a schematic structure of illumination apparatus 100 according to an embodiment.

As illustrated in FIG. 2 and FIG. 3, illumination apparatus 100 includes housing 20, light emitter 30, and condenser lens 40.

Housing 20 is tubular and includes first end surface 21 through which laser light L enters and second end surface 22 through which laser light L passing through internal space 23 exits. Although the present embodiment describes, as an example, housing 20 which is an elongated rectangular parallelepiped in external shape and has cylindrical internal space 23, housing 20 may have any shape, so long as it is a tube with a hollow inside. Other embodiments of housing 20 include a rectangular tube or a cylinder, for example. Housing 20 is formed from, for example, a metal having relatively high thermal conductivity, such as aluminum or copper.

First end surface 21 of housing 20 has communicating opening 24 which allows communication between the outside and internal space 23. Ferrule 151 attached to a tip portion of optical fiber 150 is inserted into communicating opening 24. For example, ferrule 151 is a tubular connecting member formed from a stainless steel, ceramics, a resin, or the like and is fit into communicating opening 24 to secure optical fiber 150 to housing 20.

Internal space 23 is a cylindrical space in which condensing lens 40 is disposed on optical axis L1 of laser light L.

Second end surface 22 of housing 20 has opening 25 through which laser light L exits. Opening 25 is formed into a circular shape when viewed along optical axis L1 of laser light L in internal space 23. It is to be noted that viewing along optical axis L1 is hereinafter referred to as “optical-axis view.” First inner peripheral surface 26 of housing 20 defining opening 25 protrudes toward optical axis L1 beyond second inner peripheral surface 27 of housing 20 defining internal space 23. Specifically, flange 271 protruding toward optical axis L1 and having a loop shape in the optical-axis view is formed inside housing 20 on the second-end side. The shape and size of flange 271 are not particularly limited, so long as flange 271 does not block laser light L condensed by condensing lens 40. The inner peripheral surface of flange 271 is first inner peripheral surface 26 parallel to second inner peripheral surface 27. Inside diameter D1 of first inner peripheral surface 26 is smaller than inside diameter D2 of second inner peripheral surface 27. That is to say, the thickness of housing 20 at opening 25 is greater than the thickness of housing 20 at the center portion where condenser lens 40 is disposed. Specifically, inside diameter D1 is preferably less than or equal to 5 mm. Inside diameter D2 is larger than inside diameter D1 and preferably less than or equal to 10 mm.

It is to be noted that first inner peripheral surface 26 may taper toward the second-end side. In this case, the smallest inside diameter of first inner peripheral surface 26 corresponds to inside diameter D1.

Light emitter 30 is an optical element which emits light having a wavelength different from the wavelength of laser light L when illuminated with laser light L passing through opening 25. Light emitter 30 is disposed in contact with second end surface 22 of housing 20 to block opening 25. Examples of methods for fixing light emitter 30 to second end surface 22 of housing 20 include adhering light emitter 30 to second end surface 22 using an adhesive, and fixing light emitter 30 to second end surface 22 using a known fixing mechanism not illustrated.

Light emitter 30 includes substrate 31 and phosphor component 32.

Substrate 31 is a plate mounted on second end surface 22 of housing 20, with phosphor component 32 held on substrate 31. For example, substrate 31 is formed from a light-transmissive material such as glass or sapphire. Substrate 31 is formed into a rectangular plate shape. An example of substrate 31 is a 10-mm×10-mm square plate in the optical-axis view. Phosphor component 32 is stacked on the main surface of substrate 31 which faces outside.

For example, phosphor component 32 includes phosphor particles which are dispersed and emit fluorescence when excited by laser light L, and the phosphors emit fluorescence when illuminated with laser light L. Thus, the main surface of phosphor component 32 which faces outside is the light-emitting surface. Specifically, examples of phosphor component 32 include solidified phosphor particles, a base material such as a transparent resin or glass in which phosphor particles are dispersed, or the like. That is to say, phosphor component 32 can be said to be a wavelength conversion component which converts laser light into fluorescence. Phosphor component 32 is formed into a circular plate shape in the optical-axis view and stacked on substrate 31. The outside diameter of phosphor component 32 is preferably equal to or less than 7 mm, for example.

In the present embodiment, phosphor component 32 emits white light and includes the following three types of phosphors at an appropriate proportion: a first phosphor which emits red light when illuminated with laser light L; a second phosphor which emits blue light when illuminated with laser light L; and a third phosphor which emits green light when illuminated with laser light L.

Although the types and characteristics of the phosphors are not particularly limited, phosphors have high heat resistance, for example, because relatively intense laser light is used as the excitation light. Although the type of the base material which holds the phosphors in a dispersed manner is not particularly limited, the higher the transparency is, the better it is because a higher transparency increases the efficiency of white light emission. Furthermore, the higher the heat resistance the base material has, the better it is because relatively intense laser light enters the base material.

Here, light emitter 30 may include an optical system which changes the beam diameter of laser light L, a functional film for efficiently illuminating the phosphors with laser light, or scattering particles which cause a scattering of light, for example.

Condensing lens 40 is a lens which is disposed in internal space 23 of housing 20 and condenses laser light onto light emitter 30, thereby forming a spot. Specifically, condensing lens 40 is disposed at a position at which spot diameter D3 of laser light L on light emitter 30 can be kept within a predetermined range. Here, the spot of laser light L on light emitter 30 is circular in the optical-axis view, and the predetermined range of spot diameter D3 is equal to or less than 3 mm.

Furthermore, condensing lens 40 is circular in the optical-axis view, that is, condensing lens 40 has the same shape as internal space 23 of housing 20. That is to say, condensing lens 40 has an outside diameter which is substantially the same as inside diameter D2 of internal space 23. Condensing lens 40, first inner peripheral surface 26 defining opening 25, second inner peripheral surface 27 defining internal space 23, and the spot of laser light L are concentric circles having optical axis L1 as the axis in the optical-axis view.

Here, although housing 20 includes a known holding mechanism (not illustrated) for holding condensing lens 40 at a predetermined position in internal space 23, the outside diameter of condensing lens 40 and inside diameter D2 of internal space 23 may not match depending on the type of the holding mechanism. Furthermore, although the present embodiment describes the example case where laser light L is condensed by one condensing lens 40, laser light L may be condensed by a plurality of lenses.

Next, an action of illumination apparatus 100 will be described.

Laser light L with which internal space 23 of housing 20 is illuminated by optical fiber 150 is condensed onto substrate 31 of light emitter 30 by condensing lens 40. Laser light L entering phosphor component 32 via substrate 31 is converted into white light and emitted by phosphor component 32. Light emitter 30 generates heat while illuminated with laser light L. The generated heat is dissipated by being conducted from the portion of contact between light emitter 30 and housing 20 to housing 20. Thus, a thermally stable state is constantly maintained.

Light emitter 30 becomes hottest at the spot portion of laser light L. Since flange 271 is provided closer to the spot portion than second inner peripheral surface 27 defining internal space 23 is, it is possible to conduct the heat from a relatively hot portion of light emitter 30 to flange 271. Therefore, it is possible to reduce a rise in the temperature of the spot portion on light emitter 30.

### Comparative Example

Next, illumination apparatus 200 will be described as a comparative example.

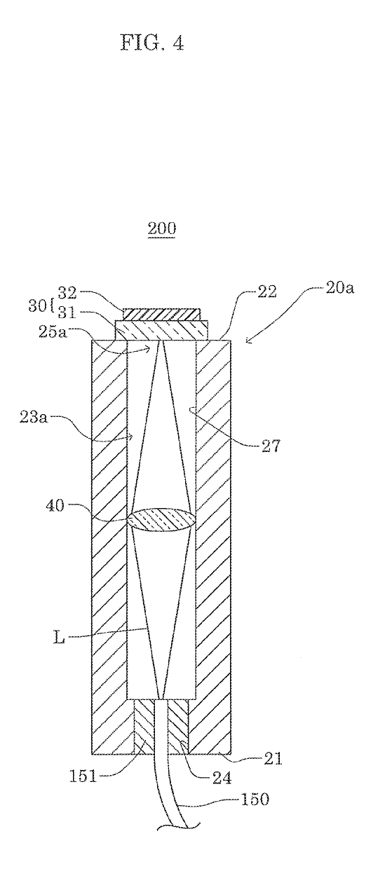

FIG. 4 is a cross section diagram illustrating a schematic structure of illumination apparatus 200 as a comparative example, and specifically corresponds to FIG. 3. It is to be noted that in the following description, the elements identical to those of illumination apparatus 100 of the above embodiment are given identical reference signs, and descriptions thereof may not be repeated.

As illustrated in FIG. 4, with housing 20a of illumination apparatus 200, opening 25a and internal space 23a of housing 20a have the same inside diameter. That is to say, as compared to illumination apparatus 100 of the present embodiment, the area of contact between light emitter 30 and housing 20a is small and the heat dissipation efficiency is not high. As compared to illumination apparatus 100 of the present embodiment, illumination apparatus 200 of the comparative example does not have flange 271, and thus the heat generated by light emitter 30 is conducted to housing 20a at a position distant from the spot portion of laser light L on light emitter 30. That is to say, with illumination apparatus 200 of the comparative example, the spot portion on light emitter 30 becomes hot as compared to illumination apparatus 100 of the present embodiment.

### Advantageous Effect, Etc

According to the present embodiment described above, in the optical-axis view, opening 25 has a circular shape larger than the spot of laser light L on light emitter 30 and smaller than the circumference of condensing lens 40. It is thus possible to increase the area of contact between light emitter 30 and housing 20, thereby increasing the heat dissipation efficiency.

First inner peripheral surface 26 of housing 20 defining opening 25 protrudes toward optical axis L1 beyond second inner peripheral surface 27 of housing 20 defining internal space 23. Such a structure allows housing 20 and light emitter 30 to be in contact at a position closer to the spot portion of laser light L on light emitter 30. Therefore, it is possible to reduce a rise in the temperature of the spot portion on light emitter 30.

### Variation 1

Next, Variation 1 according to the present embodiment will be described.

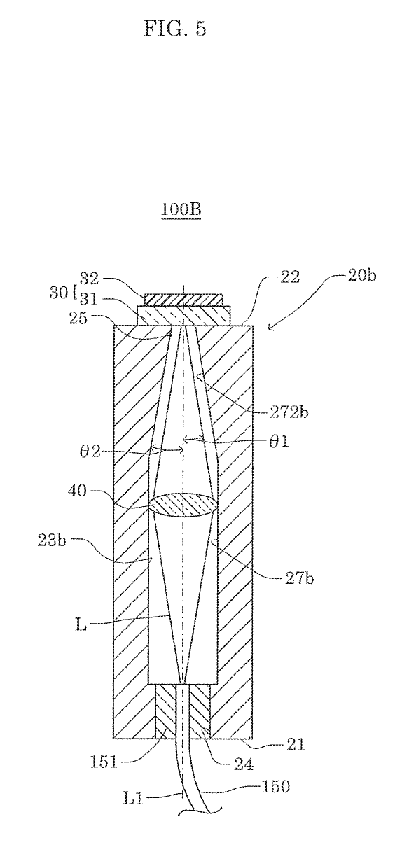

FIG. 5 is a cross section diagram illustrating a schematic structure of illumination apparatus 100B according to Variation 1, and specifically corresponds to FIG. 3. It is to be noted that in Variation 1, only the aspects different from illumination apparatus 100 according to the embodiment will be described.

With illumination apparatus 100B illustrated in FIG. 5, of inner peripheral surface 27b defining internal space 23b of housing 20b, at least a portion of a region from condensing lens 40 to opening 25 is tapered surface 272b which tapers toward light emitter 30. That is to say, the thickness of housing 20 gradually increases from the center portion of internal space 23b toward opening 25. Here, a relationship θ2≧θ1 is satisfied on the plane including optical axis L1, where θ1 is an angle formed by optical axis L1 and a marginal ray of laser light L condensed by condensing lens 40 and θ2 is an angle between optical axis L1 and tapered surface 272b. With this, tapered surface 272b cannot block laser light L condensed by condensing lens 40.

Since at least a portion of inner peripheral surface 27b defining internal space 23b is tapered surface 272b as described above, housing 20b can have an internal shape along laser light L. That is to say, because the mass of housing 20b can be increased without enlarging the external shape of housing 20b, it is possible to increase the heat capacity of housing 20b, thereby increasing the heat dissipation efficiency.

### Variation 2

Next, Variation 2 according to the present embodiment will be described.

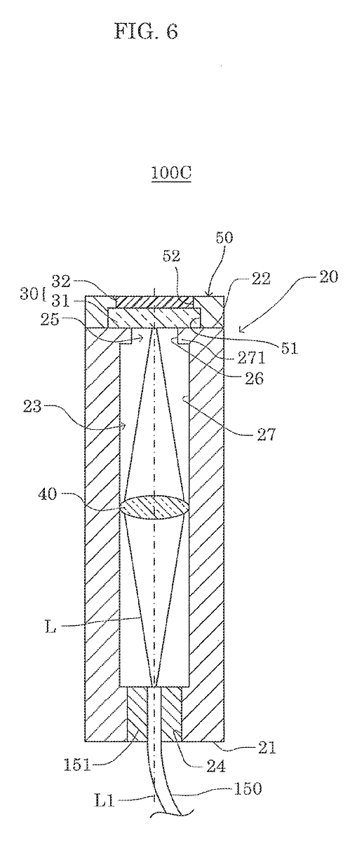

FIG. 6 is a cross section diagram illustrating a schematic structure of illumination apparatus 100C according to Variation 2, and specifically corresponds to FIG. 3. It is to be noted that in Variation 2, only the aspects different from illumination apparatus 100 according to the embodiment will be described.

As illustrated in FIG. 6, illumination apparatus 100C includes holding member 50 which holds light emitter 30 in a state of being joined to second end surface 22 of housing 20.

Holding member 50 surrounds the entire periphery of light emitter 30 in the optical-axis view and is in contact with the outer peripheral surface of light emitter 30. Specifically, holding member 50 integrally includes first contact portion 51 which is in contact with the outer peripheral surface of substrate 31 of light emitter 30 and second contact portion 52 which is in contact with the outer peripheral surface of phosphor component 32 of light emitter 30. First contact portion 51 is a looped portion having a base portion joined to second end surface 22 of housing 20. The inner peripheral surface of first contact portion 51 on the base-portion side is in contact with the outer peripheral surface of substrate 31. Second contact portion 52 protrudes toward optical axis L1 from the inner portion of first contact portion 51 on the head-portion side, and is in contact with the outer peripheral surface of phosphor component 32. Holding member 50 is formed from, for example, a metal having relatively high thermal conductivity, such as aluminum or copper.

As described above, since holding member 50 is in contact with the outer peripheral surface of light emitter 30 in a state of being joined to second end surface 22 of housing 20, the heat generated by light emitter 30 can be dissipated into housing 20 and the outside of holding member 50. The heat dissipation efficiency can thus be increased.

Here, the contact between holding member 50 and light emitter 30 includes a direct contact and an indirect contact via a filler. The direct contact and the indirect contact may be mixed. Examples of the filler include a filler having thermal conductivity such as grease. Providing a filler between light emitter 30 and holding member 50 fills the gap between light emitter 30 and holding member 50, thereby ensuring conduction of the heat generated by light emitter 30 to holding member 50.

It is to be noted that holding member 50 may be in contact with the light-emitting surface of phosphor component 32, so long as holding member 50 does not block illumination light emitted by light emitter 30. This makes it possible to increase the area of contact between light emitter 30 and holding member 50, thereby increasing the heat dissipation efficiency.

### OTHER EMBODIMENTS

Although illumination apparatuses according to the present disclosure have been described based on the above embodiment and Variations 1 and 2, the present disclosure is not limited to the above embodiment and Variations 1 and 2.

In the above embodiment, light source apparatus 149 including semiconductor laser elements is provided outside illumination apparatus 100, and laser light is transmitted to illumination apparatus 100 through optical fibers 150. However, the present disclosure is not limited to this. For example, illumination apparatus 100 may include, at the first end portion of housing 20, a semiconductor laser element which can emit laser light L having optical axis L1.

Furthermore, light emitter 30 may include a wide variety of optical systems such as an optical system which increases the beam diameter of laser light L. For example, illumination apparatus 100 may include, as an optical system, a reflective film for efficiently illuminating the phosphors with the laser light entering. Or, illumination apparatus 100 may include, as an optical system, a light-transmissive cover which diffuses and transmits light emitted by light emitter 30, for example.

The above embodiment has described the example case where opening 25 is circular in the optical-axis view. Opening 25, however, may have any shape so long as it is larger than the spot of laser light L on light emitter 30 and smaller than the circumference of condensing lens 40 in the optical-axis view. Other possible shapes include a polygon and an ellipse, for example.

While the foregoing has described one or more embodiments and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

What is claimed is:

1. An illumination apparatus which uses laser light emitted by a light source, the illumination apparatus comprising:
a housing which is tubular and includes a first end surface through which the laser light enters and a second end surface having an opening through which the laser light exits;
a light emitter which is in contact with the second end surface of the housing to block the opening, and emits light having a wavelength different from a wavelength of the laser light when illuminated with the laser light passing through the opening; and
a condenser lens which is disposed in an internal space of the housing and condenses the laser light onto the light emitter, thereby forming a spot,
wherein, when viewed along an optical axis of the laser light in the internal space, the opening has a shape larger than the spot of the laser light on the light emitter and smaller than a circumference of the condenser lens.

2. The illumination apparatus according to claim 1,
wherein a first inner peripheral surface of the housing defining the opening protrudes toward the optical axis of the laser light beyond a second inner peripheral surface of the housing defining the internal space.

3. The illumination apparatus according to claim 1,
wherein, of an inner peripheral surface defining the internal space of the housing, at least a portion of a region from the condenser lens to the opening is a tapered surface which tapers toward the light emitter.

4. The illumination apparatus according to claim 3,
wherein a relationship θ2≧θ1 is satisfied on a plane including the optical axis, where θ1 is an angle formed by the optical axis and a marginal ray of the laser light condensed by condenser lens and θ2 is an angle between the optical axis and the tapered surface.

5. The illumination apparatus according to claim 1, further comprising
a holding member joined to the second end surface of the housing and holding the light emitter by being in contact with an outer peripheral surface of the light emitter.

6. The illumination apparatus according to claim 5,
wherein a gap between the light emitter and the holding member is filled with a filler having thermal conductivity.

7. The illumination apparatus according to claim 1,
wherein the light emitter includes a substrate and a phosphor component, and
the substrate is attached to the second end surface of the housing.

8. The illumination apparatus according to claim 1,
wherein the housing is made of metal.

9. The illumination apparatus according to claim 1,
wherein the first end surface of the housing includes a connecting member which secures an optical fiber for introducing the laser light into the internal space.

10. The illumination apparatus according to claim 1, further comprising
a semiconductor laser element disposed at a first end of the housing for emitting the laser light.

11. An illumination apparatus which uses laser light emitted by a light source, the illumination apparatus comprising:
a housing including, a first end surface through which the laser light enters, a second end surface having an opening through which the laser light exits and an internal space disposed between the first end surface and the second end surface;
a light emitter, disposed in contact with the second end surface of the housing to block the opening, for emitting light having a wavelength different from a wavelength of the laser light when illuminated with the laser light passing through the opening; and
a condenser lens, disposed in the internal space of the housing, for condensing the laser light onto the light emitter, thereby forming a spot,
wherein a thickness of the housing at the opening is greater than a thickness of the housing at a center portion where the condenser lens is disposed.

12. The illumination apparatus according to claim 11,
wherein a thickness of the housing gradually increases from the center portion toward the opening.
